(19) United States
(12) Patent Application Publication
(10) Pub. No.: US 2014/0129432 A1
(43) Pub. Date: May 8, 2014

(54) STATEMENT COLLECTION, CONSOLIDATION, AND FACILITATION

(71) Applicant: BANK OF AMERICA CORPORATION, Charlotte, NC (US)

(72) Inventors: Carrie Anne Hanson, Charlotte, NC (US); Leland E. Modesitt, Charlotte, NC (US); Katherine Dintenfass, Charlotte, NC (US); Alexander C. Wittkowski, Charlotte, NC (US); Laura Corinne Bondesen, Charlotte, NC (US); Marc Lance Warshawsky, Charlotte, NC (US); Jon R. Wolf, Charlotte, NC (US); Scott R. Enscoe, Charlotte, NC (US); Brett Newman, Burlingame, CA (US); Leo Kopelow, San Francisco, CA (US); Yameng Li, Berkeley, CA (US); Nicole Chen, San Francisco, CA (US); Nicholas Sharp, San Francisco, CA (US)

(73) Assignee: BANK OF AMERICA CORPORATION, Charlotte, NC (US)

(21) Appl. No.: 13/667,437

(22) Filed: Nov. 2, 2012

(51) Int. Cl. G06Q 20/14

(52) U.S. Cl. 705/40

(57) ABSTRACT

Embodiments of the invention include systems, methods, and computer-program products for providing vendor statement management for a user, including the receiving, monitoring, and paying of statements with no or minimal user required interaction. As such, the invention provides a facilitated access to accurate statement information from all of the vendors or service providers consolidated into one reliable source. Embodiments of the present invention provide a system for statement management. Specifically, embodiments of the invention allow for determining vendor statements associated with a user, consolidating the found vendor statements, monitoring those statements, notifying user if vendor statement need attention or payment, and providing payment from a payment account for the vendor statement.

### BACKGROUND

Typically, individuals receive several statements from many vendors that the individual needs to manage in order to tender payment for the statements timely. The statements may be provided to an individual in many different ways, including being mailed, emailed, or the like. In this way, an individual may have to keep track of the methods of receiving the statement, the date payment is due for each statement, and how (or what account) the individual may use to satisfy the statement.

Recently, individuals have been using electronic devices to calendar or remind them of statements becoming due. However, typically individuals need to input the statements into the calendar and subsequently have to manually pay the statement using a selected payment account.

Therefore, a need exists for a way to manage statements and the payment thereof.

### BRIEF SUMMARY

Embodiments of the present invention address the above needs and/or achieve other advantages by providing apparatuses (e.g., a system, computer program product and/or other devices) and methods for managing user statements, including the receiving, monitoring, and paying of statements with no or minimal user required interaction. As such, the invention provides a facilitated access to accurate statement information from all of the vendors or service providers consolidated into one reliable source.

Embodiments of the present invention provide a system for statement management. Specifically, embodiments of the invention allow for determining vendor statements associated with a user, consolidating the found vendor statements, monitoring those statements, notifying user if vendor statement need attention or payment, and providing payment from a payment account for the vendor statement.

In some embodiments, the system may allow for determining vendor statements associated with a user. In some embodiments, the vendor statements may be determined automatically. In other embodiments, the user may provide information associated with the vendor statement to the system. The system may receive the statements directly from the vendor, from a user, from a financial institution account, or the like. In some embodiments, the system may recognize payments for past vendor statements from a user's financial institution account. In this way, the system may recognize a regular weekly/monthly/yearly payment to a particular vendor or particular vendor account. In this way, the system may recognize that payment as being a regular vendor statement. Once recognized the system may determine the statement regularity, statement amount, and statement number, if necessary, and automatically receive future statements and add them to the user's statement management system. In other embodiments, the system may recognize a vendor statement sent to a user via email. In this way, the system may recognize a vendor statement sent to the user's email account. Once identified, the system may determine the statement regularity, statement amount, and statement number, if necessary, and automatically retrieve the statement from the user's email and add it to the user's statement management system. In some embodiments, the system may recognize captured images of a vendor statement. In this way, the user may capture an image using an image capture device, such as a camera or the like and the system may recognize the vendor, the vendor account, the statement amount, and the like. The system may then add the determined information to the user's statement management system.

In some embodiments, the system may consolidate the vendor statements recognized or inputted into the system. In this way, all of the various statements that may be received at any given time may be consolidated into the user's statement management system. In this way, the user may view all of his/her outstanding, previously paid, and future statements.

In some embodiments, the system may monitor the consolidated statements. Consolidating the statements allows the system to monitor the due dates, user reminders, and the like for every statement the user may have. In this way, there is one location that a user may have access to view all statements, all due dates, amounts, as well as allowing the user to set up various options such as reminders, payment dates, viewing payment history, and the like.

In some embodiments, the system may provide notification to user if vendor statements need attention. In this way, if a statement is coming due, if a user set a notification, such as a payment or if other user attention is needed, the system may notify the user. Furthermore, the system may notify the user of any discrepancies in statements, such as a difference in statement amount compared to amount paid or a difference in previous statement amount compared to current statement amount due.

In some embodiments, the system may also provide payment from a payment account for the vendor statements stored within the user's statement management program that are coming due. In this way, the system may determine one or more vendor statements coming due and provide, automatically, payment to the vendor for the statement. Because of the unique position of a financial institution, the financial institution operating the system may be able to select and provide payment for a statement based on user selection and/or user statement payment history.

Embodiments of the invention relate to systems, methods, and computer program products for: determining one or more vendor statements, wherein the one or more vendor statements are associated with the user and require satisfying by the user; receiving the determined one or more vendor statements; determining vendors associated with the one or more vendor statement; retrieving, automatically, new vendor statements from the vendors of the received one or more vendor statements; consolidating the received one or more vendor statements and the retrieved new vendor statements, wherein the consolidated vendor statements are associated with the user; determining critical vendor data associated with the consolidated vendor statements, wherein the critical vendor data includes satisfaction dates and payment amount due for satisfaction; and providing, automatically, payment for satisfaction of the consolidated vendor statements directly to the vendor.

In some embodiments, determining one or more vendor statements comprises recognizing regular payments from the user's financial institution account to a vendor as a potential vendor statement and contacting the vendor or user to request the potential vendor statement for vendor statement management. In some embodiments, determining one or more vendor statements comprises recognizing the vendor statement when the vendor statement is sent to the user, wherein the vendor sends the vendor statement to the user electronically. In yet other embodiments, determining one or more vendor statements comprises recognizing a captured image of the vendor statement, wherein the captured image is captured via an image capture device, such as a camera.

In some embodiments, the invention further comprises determining a user payment device for satisfaction of vendor statements is determined by one or more of vendor statement payment history, artificial intelligence, or user input.

In some embodiments, vendor data comprise one or more of vendor account, payment required for satisfaction, past user payment device for satisfying a previous vendor statement, and user name associated with the vendor.

In some embodiments, the invention further comprises notifying the user of any pending critical vendor data and pending user preferences associated with any of the one or more consolidated vendor statements.

In some embodiments, providing payment for satisfaction of the consolidated vendor statements directly to the vendor occurs without user interaction, wherein providing payment for satisfaction occurs before the critical vendor date. In some embodiments, the invention further comprises continually monitoring the vendor and vendor statement associated with the satisfied vendor statement for confirmation of satisfaction.

In some embodiments, the invention further provides for flagging of discrepancies in the received one or more vendor statements and the retrieved new vendor statements vendor statements, wherein the discrepancies are differences in previously received or retrieved vendor statements and currently received or retrieved vendor statements.

In some embodiments, the invention further comprises monitoring vendor statement history for a user. In some embodiments, the vendor statement is one or more of an invoice for services rendered or a bill for purchasing a product.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating a user statement management program method for providing vendor statement management, in accordance with one embodiment of the present invention;

FIG. 2 provides a user statement management system environment, in accordance with one embodiment of the present invention;

FIG. 3 provides a process flow illustrating methods of determining vendor statements associated with a user, in accordance with one embodiment of the present invention;

FIG. 4 provides a process flow illustrating system process for receiving vendor statements, in accordance with one embodiment of the present invention;

FIG. 5 provides a process flow illustrating system processing for a user statement management program, in accordance with one embodiment of the present invention;

FIG. 6 provides a process flow illustrating user decision process for using a statement management program, in accordance with one embodiment of the present invention; and

FIG. 7 provides user interfaces for methods of determining vendor statements associated with a user, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. A “statement” as used herein may refer to any bill, transaction statement, invoice, payment notification, note, payment schedule, or other statement that may require a user payment or later attention. A “payment device” as used herein may refer to any means of payment for a product of a transaction. As such a payment device may include, but is not limited to a credit card, debit card, currency, paper money, coin money, lines of credit, gift cards, checks, virtual currency, electronic payment means, or the like. Furthermore, a “vendor” as used herein may refer to any third party that a user may have transacted with for products, services, or the like that may have a statement associated with the transaction. In this way, a vendor may be a merchant, service provider, contractor, business, individual or entity that may have transacted with the user and be providing the user with a statement associated with the same.

Some portions of this disclosure are written in terms of a financial institution's unique position with respect to payment account and payment device providers. As such, a financial institution may be able to utilize its unique position to determine vendor statements based on financial institution account history, determine financial accounts that a user utilizes for payment of a statement, provide payment for a statement, and to monitor payment history.

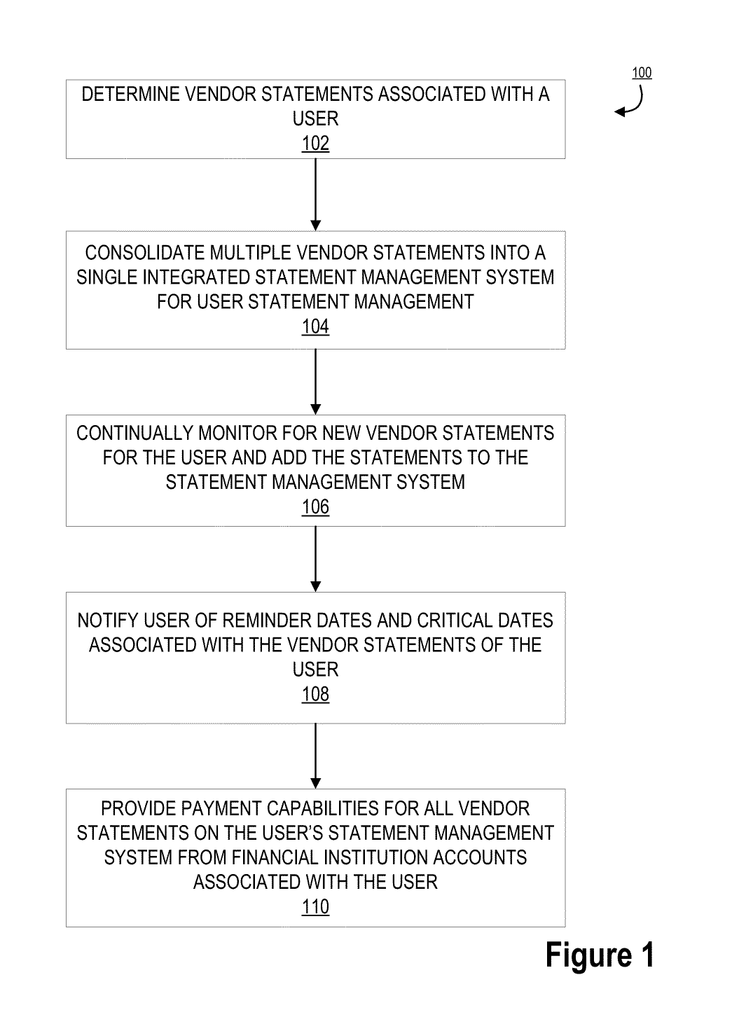

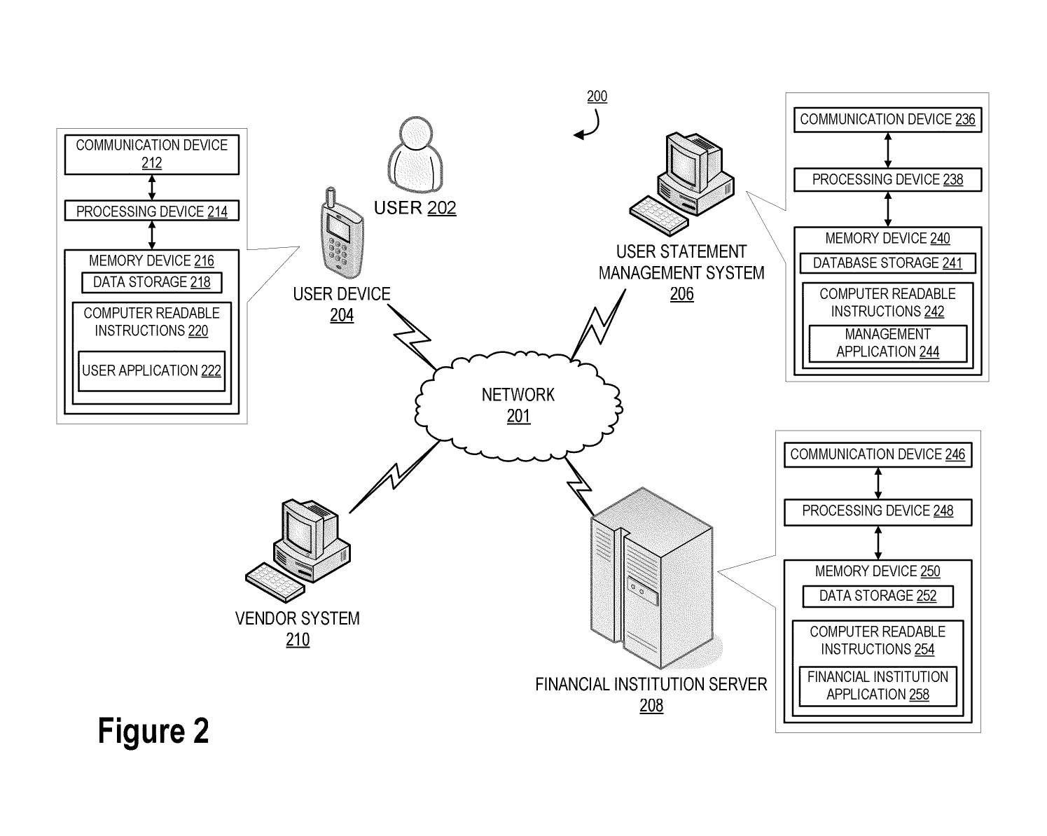

FIG. 1 provides a high level process flow illustrating a user statement management program method for providing vendor statement management 100, which will be discussed in further detail throughout this specification with respect to FIG. 2 through FIG. 7. The first step in the process 100, as illustrated in block 102 is determining vendor statements associated with a user. The system may determine vendor statements associated with a user various ways. In some embodiments, the system may determine vendor statements for a user by recognizing regular payments form the user's financial institution accounts.

Next, as illustrated in block 104, the system may consolidate multiple vendor statements into a single integrated statement management system for user statement management. In this way, all of the various statements that may be received at any given time may be consolidated into the user's statement management system. In this way, the user may view all of his/her outstanding, previously paid, and future statements.

As illustrated in block 106, the system may continually monitor the user's records for new vendor statements for the user and subsequently add the statements to the user's statement management system. As such, the system may be able to monitor user email, records, financial institution, and the like to determine if new vendor statements have been issued to the user. If new vendor statements have been issued to the user, the system may be able to access the statement and consolidate it into the user's statement management system. In some embodiments, the system may be able to determine, access, and consolidate the new statement into the user's statement management system automatically, independent of any user input. In other embodiments the system may receive user input in order to determine, access, and consolidate the new statement into the user's statement management system. Furthermore, the consolidation allows for a single location for all vendor statements associated with a user. As such, the user may have access to view all statements, all due dates, amounts, as well as allowing the user to set up various options such as reminders, payment dates, viewing payment history, and the like.

Next, as illustrated in block 108, the system may notify the user of reminder and critical data, such as critical dates associated with the vendor statements. In this way, if a statement is coming due, if a user set a notification, such as a payment or if other user attention is needed, the system may notify the user. Furthermore, the system may notify the user of any discrepancies in statements, such as a difference in statement amount compared to amount paid or a difference in previous statement amount compared to current statement amount due.

Finally, as illustrated in block 110, the system may provide payment capabilities for all vendor statements on the user's statement management system. In this way, the system may directly access the user's financial institution accounts and be able to provide authorized payment for fulfillment of one or more vendor statements associated with the user with a user payment device. In this way, the system may determine one or more vendor statements coming due and provide, automatically, payment to the vendor for the statement. Because of the unique position of a financial institution, the financial institution operating the system may be able to select and provide payment device for a statement based on user selection and/or user statement payment history.

FIG. 2 provides a user statement management system environment 200, in accordance with one embodiment of the present invention. As illustrated in FIG. 2, the financial institution server 208 is operatively coupled, via a network 201 to the user device 204, the user statement management system 206, and the vendor system 210. In this way, the financial institution server 208 can send information to and receive information from the user device 204, user statement management system 206, and the vendor system 210 to provide facilitated access to accurate statement information from all vendors consolidated through one source, with the ability to monitor and provide payment for the vendor statements.

FIG. 2 illustrates only one example of an embodiment of a user statement management system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual that has entered into a statement generating action with various vendors. As such, in some embodiments, the user 202 may have made one or more transaction, such as a financial transaction, service transaction, payment schedule, or the like with a vendor. The transaction may be made at a point-of-transaction (POT) of a merchant, online or offline, at the merchant's place of business and/or other transaction means. The purchase may be made by the user 202 using any type of payment device available to the user 202, such as, but not limited to cash, credit cards, debit cards, gift cards, checks, lines-of-credit, time interval payments, or the like. Furthermore, in some embodiments, the user 202 may be a merchant or a person, employee, agent, independent contractor, or the like acting on behalf of the merchant to enter into a transaction or statement generating action.

As illustrated in FIG. 2, the user statement management system 206 generally comprises a communication device 236, a processing device 238, and a memory device 240. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 238 is operatively coupled to the communication device 236 and the memory device 240. The processing device 238 uses the communication device 236 to communicate with the network 201 and other devices on the network 201, such as, but not limited to the financial institution server 208, the vendor system 210, and the user device 204. As such, the communication device 236 generally comprises a modem, server, or other device for communicating with other devices on the network 201.

As further illustrated in FIG. 2, the user statement management system 206 comprises computer-readable instructions 242 stored in the memory device 240, which in one embodiment includes the computer-readable instructions 242 of a management application 244. In some embodiments, the memory device 240 includes database storage 241 for storing data related to the management application 244 including but not limited to data created and/or used by the management application 244.

In the embodiments illustrated in FIG. 2 and described throughout much of this specification, the management application 244 allows for the facilitation of user 202 access to accurate statement information from all vendors within a consolidated program. As such, the management application 244 may search and find vendor statements associated with the user 202, consolidate vendor statements, create the user's statement management program, determine critical data associated with the vendor statements, monitor the statement management program, and communicate with the financial institution server 208 for payment of statements.

The management application 244 may search and find vendor statements associated with the user 202. In some embodiments, the user 202 may provide the management application 244 with the vendor statement or information associated therewith. In other embodiments, the management application 244 may search and find vendor statements associated with the user 202 automatically. In this way, the management application 244 may communicate using the communication device 236 with other systems on the network 201, such as the financial institution server 208, the user device 204, or the vendor system 210 to access vendor statements associated with the user 202. In this way, the management application 244 may receive statements directly from the vendor, from the user 202, or from a financial institution. The financial institution may be able to determine vendor statements based on user 202 account history, such as payment history.

In some embodiments, the management application 244 may automatically search and find vendor statements associated with a user 202 using a proactive statement recognition technologies. In other embodiments, the system may receive vendor statements via input from a user 202, vendor, or other entities.

Once the management application 244 finds or accesses a vendor statement, the management application 244 may determine critical information from the vendor statement. This information may include, but is not limited to determining if the vendor statement is associated with a user 202 of the user statement management program, statement account number, payment amount associated with the statement, statement regularity, statement amount regularity, vendor associated with the statement, critical dates associated with the statement, and the like. Furthermore, the management application 244 may also determine the payment device typically used by the user 202 to pay for the statement.

In some embodiments, once the management application 244 determines information associated with the vendor statement, the management application 244 may store that information in the memory device 240 in association with other vendor statements associated with a particular user 202.

The management application 244 allows for the consolidation of vendor statements. As such, the management application 244 may store information associated with vendor statement in the memory device 240 in association with other vendor statements associated with a particular user 202. As such, the management application 244 creates a consolidated location that stores all vendor statements associated with each user 202 having a user statement management program active. The vendor statements are stored associated with users 202. As such, vendor statements from Vendor 1, Vendor 2, and the like may all be stored together, if they are associated with the same user 202. In this way, the management application 244 provides a single consolidated location for accurate statement information for all vendor providers.

The management application 244 may also create the user's statement management program. With the compiled vendor statements associated with each user 202, the management application 244 creates the user's statement management program. In this way, the management application 244 may receive all of the vendor statements and user 202 input associated with the same. User 202 input may include user preferences, payment accounts associated with vendors, payment schedules, and the like. As such, the management application 244 communicates with the user 202 via the user device 204 to determine user 202 preferences.

Creation of the user's statement management program also allows the management application 244 to communicate critical data, such as due dates, scheduled payments, new vendor statements received at the management application 244, or the like. As such, the consolidation and creation of the user's statement management program allows for a single reliable source for all vendor statements (such as bill information) to be accessed and viewed accurately.

The management application 244 may also determine critical data associated with the vendor statements on the user's statement management program. In some embodiments, the management application 244 may determine critical data automatically based on information received from the vendor statement. In this way, the management application 244 may review the vendor statement and determine the critical data associated therewith. This critical data may be determined by the management application 244 based on programmed criteria, artificial intelligence, or the like. In this way, the management application 244 may determine critical data, such as due dates, vendor, vendor account, vendor address to direct payment, discrepancies in the statement, ensure vendor statement matches user 202, date of vendor service, payment plan options, and/or the like. In some embodiments, the user 202 may manually input critical data associated with the vendor statements. In this way, the user 202 may be able to set up a payment schedule, payment date, reminder dates, and/or the like.

In this way, the management application 244 may consolidate all of the user's vendor statements into one reliable source that determines and monitors the vendor statements and critical data associated with the same such that no critical dates or payments are missed or forgotten.

As such, the management application 244 may also monitor each user's statement management program. In this way, the consolidated vendor statements for a user 202 may each be monitored for critical data that may require user 202 notification. Furthermore, the management application 244 may monitor for new or incoming vendor statements. In some embodiments, the system may monitor the consolidated statements. As such the management application 244 is able to monitor the due dates, vendor, vendor account, vendor address to direct payment, discrepancies in the statement, ensure vendor statement matches user 202, date of vendor service, payment plan options, and/or the like for every statement the user 202 may have. In this way, there is one location that a user 202 may have access to view all statements, all due dates, amounts, as well as allowing the user 202 to set up various options such as reminders, payment dates, viewing payment history, and the like such that the management application 244 allow for automatic monitoring and communicating of data within the single location.

The management application 244 may also communicate with the financial institution server 208 to provide payment for vendor statements. In this way, when statements within the user's statement management program are coming close to a critical due date, the management application 244 may provide payment for these statements. As such, if a user 202 forgets or is not able to direct payment in time, the management application 244 may provide the payment such that no negative repercussions from non-payment may occur. In some embodiments, the management application 244 is in communication with the financial institution server 208 to send and receive information associated with user 202 financial institution accounts. In this way, the management application 244 may communicate with the financial institution server 208 to send payment account information of a user 202 to a vendor system 210 to provide payment for a vendor statement. In some embodiments, the user 202 may manually provide the management application 244 with the information associated with when, the account number, and payment information. In this way, the management application 244 may provide payment information directly to the vendor system 210 based on the user 202 input. In other embodiments, the management application 244 may automatically provide the vendor system 210 with payments to satisfy vendor statements. In some embodiments, the selected payment method may be determined based on the user's payment history associated with the vendor statement. In this way, the management application 244 may communicate with either the vendor system 210 or the financial institution server 208 to determine user 202 payment history. As such, the management application 244 may automatically make a payment to satisfy a vendor statement using a payment device that the user 202 has used in the past to satisfy a previous statement for that vendor.

As illustrated in FIG. 2, the financial institution server 208 may include a communication device 246, processing device 248, and a memory device 250. The processing device 248 is operatively coupled to the communication device 246 and the memory device 250. The processing device 238 uses the communication device 246 to communicate with the network 201 and other devices on the network 201, such as, but not limited to the user device 204, user statement management system 210, and/or the vendor system 210 over a network 201. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to the financial institution application 258 including but not limited to data created and/or used by the financial institution application 258.

In the embodiments illustrated in FIG. 2 and described throughout much of this specification, the financial institution application 258 allows for recognition and determining vendor statements, recognition of payment devices associated with each vendor statement, and providing a payment device to the vendor system 210 for satisfying the vendor statement.

The financial institution application 258 may provide one means for the user statement management system 206 to recognize and determine vendor statements associated with a user 202. In this way, the financial institution application 258 may review user 202 accounts to determine potential vendor statements. The financial institution application 258 may do this in several ways, including tracking payment accounts for patterns, reviewing vendors that a user 202 utilizes a payment account for, or recognizing indicators associated with payment account data to determine vendor statements.

The financial institution application 258 may track potential patterns associated with each of the user's payment devices to determine potential vendor statements associated with a user 202. For example, there may be a pattern that a user 202 makes a payment from his/her payment device account on the same date each month. For example, the financial institution application 258 may recognize that a user 202 provides payment to Vendor A on the same date each month for several months in a row. The financial institution application 258 may notice this pattern and subsequently determine if the payee is a vendor statement.

The financial institution application 258 may review vendors that a user 202 utilizes payment accounts for payment to determine if the vendor is one that typically provides vendor statements. For example, a vendor that a user 202 utilizes a payment account to provide payment to may be a cable company. As such, the financial institution application 258 may recognize that the cable television company is one that typically uses vendor statements. In this way, the financial institution application 258 may determine that the cable television company statement should be added to the user statement management program.

The financial institution application 258 may also recognize indicators associated with payment accounts to determine vendor statements. In this way, the financial institution application 258 may recognize dates, account numbers, routing information, and other data typically associated with a vendor account that may be associated with the payment account of the user 202. In this way, the financial institution application 258 may recognize these indicators and further determine if these are vendor statements that should be added to the user statement management program.

The financial institution application 258 may also recognize payment devices associated with each vendor statement. In this way, the financial institution application 258 may communicate with the user statement management system 206 to determine the payment device account associated with the payment device that the user 202 historically has used for payment of the vendor statement. In this way, if the user statement management system 206 needs to automatically provide payment for a vendor statement of the user 202, the system may be able to provide the vendor system 210 with payment for the user's payment account that the user 202 historically uses to pay that vendor.

The financial institution application 258 may also provide the payment device to the vendor system 210 to satisfy the vendor statement. In this way, the financial institution application 258 may communicate with the user statement management system 206 to determine when and what payment account associated with the user 202 to use for payment of a vendor statement. Because the financial institution server 208 stores account information for payment accounts associated with the user 202 in the data storage 252, the financial institution application 258 may have access to the payment account information necessary to complete a payment to a vendor. As such, upon receipt of communication from the user statement management system 206, the financial institution application 258 may access the appropriate user 202 payment device account and provide the necessary information to the vendor system 210 to satisfy the vendor statement.

FIG. 2 also illustrates a user device 204. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the user statement management system 206, vendor system 210, and the financial institution server 208. As such, the communication device 212 generally comprises a modem, server, or other device for communicating with other devices on the network 201.

As further illustrated in FIG. 2, the user device 204 comprises computer-readable instructions 220 and data storage 218 stored in the memory device 216, which in one embodiment includes the computer-readable instructions 220 of a user application 222. In this way, the user application 222 allows a user 202 to have and/or support a mobile wallet and/or online banking interface. A “user device” 204 may be any mobile communication device, such as a cellular telecommunications device (e.g., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single user device 204 is depicted in FIG. 2, the system environment 200 may contain numerous user devices 204.

In some embodiments, the user application 222 allows a user 202 to utilize his/her user device 204 as a user statement manager to access, provide input, receive notifications based on the monitoring of present, past, and future vendor statements as well as information associated with the same.

The user application 222 may allow a user 202 to utilize his/her user device 204 to access the user statement management program associated with the user 202. As such, the user application 222 may communicate using the network 201 with the user statement management system 206 to access the user's statement management program. In this way, the user application 222 may authorize the user device 204 as being associated with the user 202 such that the user device 204 may be able to securely access the user's statement management program.

The user application 222 may also allow a user 202 to add information to his/her user statement management program. In this way, the user 202 may be able to input payment dates, set critical dates, add comments, notes, payment schedules, preferred payment accounts, add vendor statements, and/or the like. The user 202 may be able to input this data via text, voice, image recognition, or the like. The user device 204 may communicate the information associated with the added data via the communication device 212 through a network 201 to the financial institution server 208 and/or the user statement management system 206.

The user application 222 may also receive notifications associated with the monitoring of vendor statements within the user's statement management program. In this way, the user 202 may be able to monitor all critical data, statistics, payments, or other happenings associated with the vendor statements on the user's statement management program.

Finally, the user application 222 allow the user 202 to utilize the user device 204 as a mobile wallet for transactions, such as payments of vendor statements. In this way, the user 202 may use his/her user device 204 to make a payment to a vendor to settle a vendor statement, make a purchase of a product, and the like.

FIG. 2 also illustrates a vendor system 210. The vendor system 210 is operatively coupled to the financial institution server 208, user device 204, and/or the user statement management system 206 through the network 201. The vendor system 210 has systems with devices the same or similar to the devices described for the financial institution server 208, user device, and/or the user statement management system 206 (e.g., communication device, processing device, and memory device). Therefore, the vendor system 210 may communicate with the financial institution server 208, user device 204, and/or the user statement management system 206 in the same or similar way as previously described with respect to each system. The vendor system 210, in some embodiments, is comprised of systems and devices that allow for sending and receiving vendor statements and/or information associated therewith. In this way, the vendor system 210 may send vendor statements directly to the user statement management system 206 for addition to the user statement management program.

Furthermore, the vendor system 210 may receive payments for the satisfaction of vendor statements from the user device 204, user statement management system 206, or the financial institution server 208.

The vendor system 210 may also communicate with the other system of the network 201 to send or receive negotiations or settlement offers for vendor statements, including, but not limited to changes in vendor statement due dates, amounts due, payment schedules, and the like.

It is understood that the servers, systems, and devices described herein illustrate one embodiment of the invention. It is further understood that one or more of the servers, systems, and devices can be combined in other embodiments and still function in the same or similar way as the embodiments described herein.

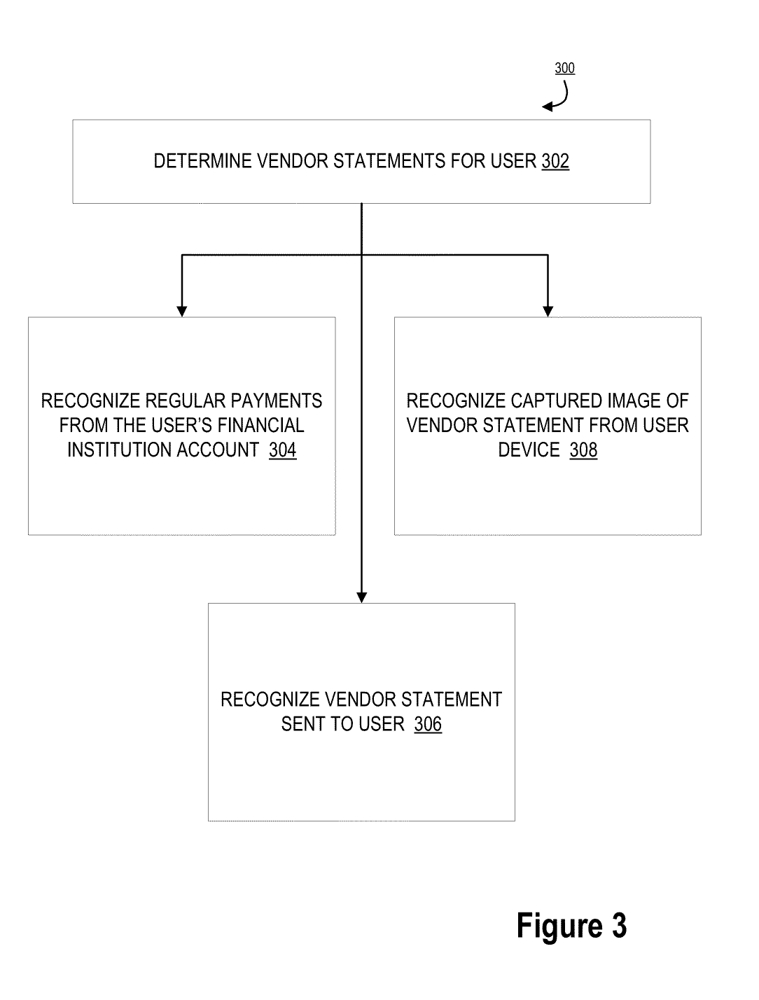

FIG. 3 illustrates a process map of methods of determining vendor statements associated with a user 300, in accordance with one embodiment of the present invention. As illustrated in block 302, the system may have to determine vendor statements for a user 202 such that the vendor statements may be compiled for the user statement management program. In some embodiments, the vendor statements may be determined automatically. In other embodiments, the user may provide information associated with the vendor statement to the system. The system may receive the statements directly from the vendor, from a user, from a financial institution account, or the like.

There are three main ways of determining vendor statements for a user 302. As illustrated in block 304, one way is to recognize regular payments from the user's financial institution accounts. In this way, the system may recognize a pattern of regular weekly/monthly/yearly payments to a particular vendor or particular vendor account. Because of the unique position of the financial institution, the system may have access to payments made/received from various user 202 payment device accounts. As such, the system may be able to monitor activity of the user 202 payment device account to detect patterns of payment. The system may then be able to review the patterns and determine vendor statements associated therewith. Once recognized, the system may determine the statement regularity, statement amount, and statement number, if necessary, and automatically receive future statements and add them to the user's statement management program.

Next, as illustrated in block 306, another way to determine vendor statements associated with a user 202 is by recognizing vendor statements sent to user 202. In some embodiments, the vendor statements may be recognized because they are sent electronically to the user device 204 over a network 201 in which the system may monitor and recognize the vendor statements. This electronic sending may be via email, text message, or other electronic means of transmitting the statement. In other embodiments, the user 202 may request the vendor send the vendor statements directly to the system. In this way, the system may recognize the vendor statement as being associated with the user 202 and compile that vendor statement into the appropriate user's statement management program. For example, the system may recognize a vendor statement sent to a user 202 via email. Once identified, the system may determine the statement regularity, statement amount, and statement number, if necessary, and automatically retrieve the statement from the user's email and add it to the user's statement management program.

As illustrated in block 308 another way to determine vendor statements associated with a user 202 is by recognizing captured images of vendor statement. The captured images may be captured by a user 202 using an image capture device, such as a camera, user device 204, or the like. In other embodiments, the user 202 may be using a text capture device, such as a scanner or facsimile. Once the system receives a captured image or text associated with a vendor statement, the system may recognize the vendor, the vendor account, the statement amount, frequency of the statement, and the like. The system may then add the determined information to the user's statement management program.

In all of the ways to determine vendor statements for user illustrated in FIG. 3, the system may follow up with the vendor of the received vendor statement. In this way, the system may be able to directly receive the vendor statement for any future vendor statements. As such, the user 202 may have limited interaction with the vendor, such that the user 202 may not have to capture another image of the vendor statement or the like. In this way, once the system has received one vendor statement from a particular vendor, the system may be authorized to pull future vendor statements to the user's statement management program.

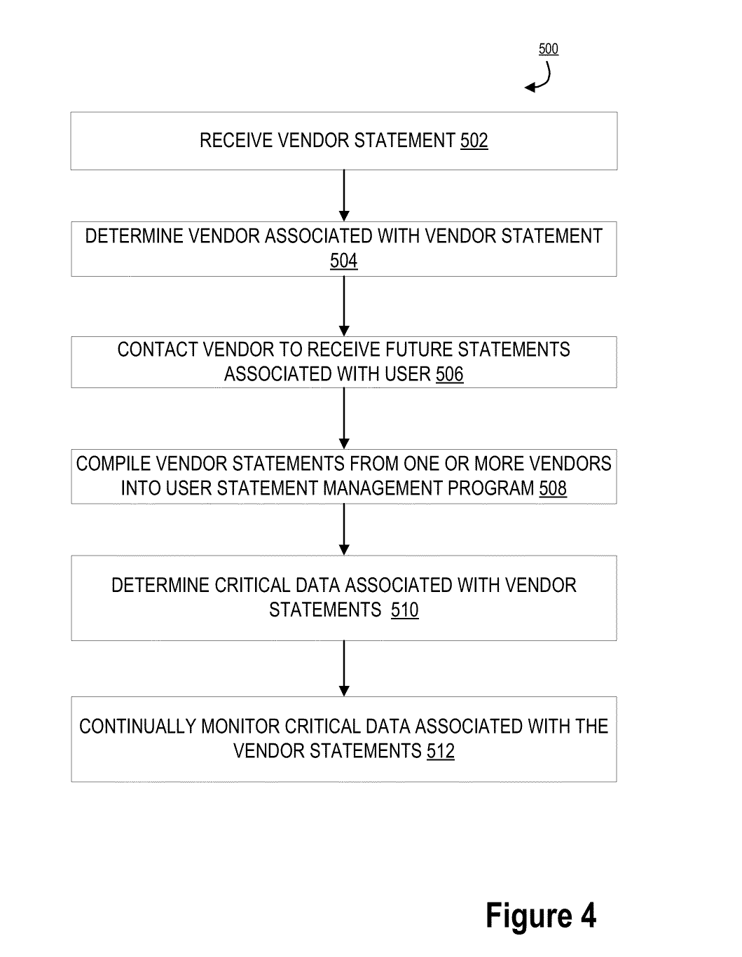

FIG. 4 illustrates a process flow illustrating system process for receiving vendor statements 500, in accordance with one embodiment of the present invention. As illustrated in block 502, the system may receive vendor statements. The vendor statements may be received in any of the ways described above in FIG. 3 or the vendor statements may be received directly from the vendor itself.

Next, as illustrated in block 504, the system may determine the vendor associated with the vendor statement. This includes determining the vendor, vendor contact information, the statement amount due, previous statement amounts, the vendor account number associated with the statement, acceptable payment means for satisfying the vendor statement, dates of previous payment tendered by user 202, payment device account used by the user 202 to make previous payments, and the like.

After the system has determined the vendor associated with a received vendor statement, the system may, as illustrated in block 506, contact the vendor directly to receive future statements associated with the user 202. In some embodiments, this step of contacting the vendor directly may need to be authorized by the user 202 prior to the system reaching out to the vendor. In other embodiments, the system may contact the vendor automatically to receive future statements associated with a user 202. In this way, future statements may be sent directly to the user's statement management program, such that the user 202 may not have to worry about critical dates associated with the vendor statement, but simply allow the system to monitor the vendor statements and to make the necessary payments to the appropriate vendor prior to a critical payment date passing.

Next, as illustrated in block 508, the system may compile all vendor statements from one or more vendors, into the user's statement management program. In this way, the user 202 may have all vendor statements for him/her consolidated into one reliable source that has monitoring and vendor statement management services and features.

As illustrated in block 510, once the system has compiled all of the vendor statements from the vendors into the user's statement management program, the system may determine the critical data associated with the vendor statements. Critical data may include, but is not limited to due dates, scheduled payments, new vendor statements received, amounts due in vendor statement, discrepancies in statements, vendor account, vendor address to direct payment, ensure vendor statement matches user 202, date of vendor service, payment plan options, and/or the like. In this way, all of the critical data associated with each of the vendor statements may be consolidated and provided to the user 202 via his/her user statement management program. In some embodiments, the system may determine critical data automatically based on information received from the vendor statement. In this way, the system may review the vendor statement and determine the critical data associated therewith based on scanned data, programmed criteria, artificial intelligence, or the like. In some embodiments, the user 202 may manually input critical data associated with the vendor statements. In this way, the user 202 may be able to set up critical data points and appropriate actions associated therewith. The appropriate actions may be the system notifying the user 202 of a critical data point or automatically acting based on a critical data point.

Next, as illustrated in block 512 the system may continually monitor critical data associated with the vendor statements. As such, the consolidation and creation of the user's statement management program allows for a single reliable source for all vendor statements (such as bill information) to be continually monitored by the system, so that critical data associated with the vendor statements on the user's statement management program may be identified and subsequently provided appropriate action.

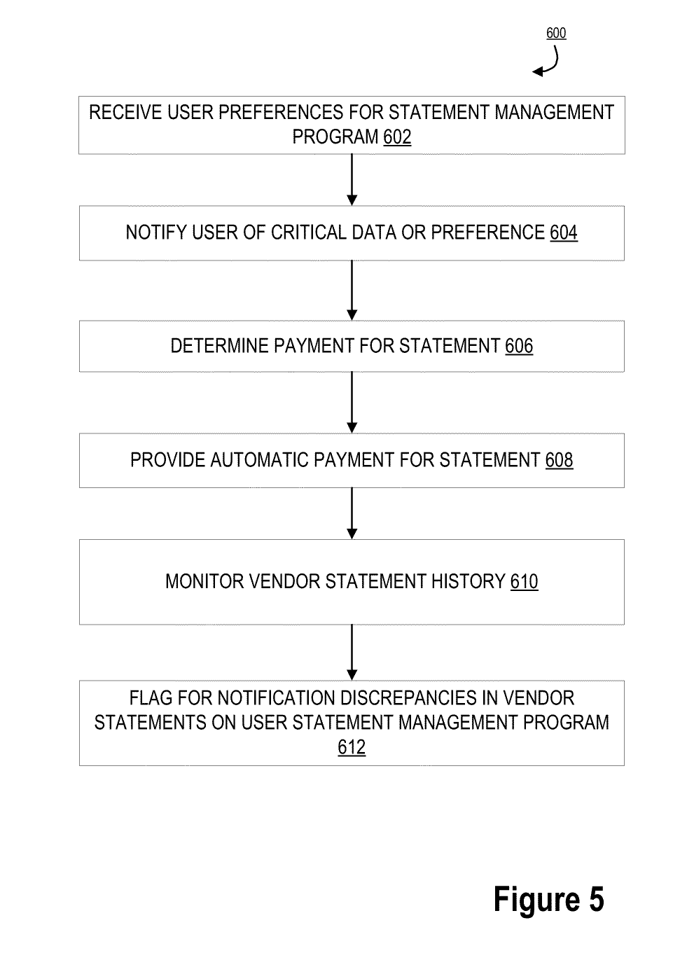

FIG. 5 illustrates a process flow for system processing of a user statement management program 600, in accordance with one embodiment of the present invention. FIG. 5 allows for user 202 input and user notification associated with the user statement management program. As such, in some embodiments, the steps illustrated in FIG. 5 are/or could be occurring after the process steps illustrated in FIG. 4. As illustrated in block 602 the system may receive user preferences for the statement management program. User preferences may include, but are not limited to, payment accounts, payment schedules, payment preferences such as preferred payment device accounts for various vendor statements, providing critical data, setting critical dates, and/or the like.

Once the system has received vendor statements, as well as, in some embodiments, other steps of the process illustrated in FIG. 4, and has received user preferences in block 602, the system may notify the user 202 of critical data or preferences upcoming, as illustrated in block 604. In this way, the system may recognize information associated with the user statement management program, such as information associated with critical data, user preferences, vendor statements, payment schedules, and the like and provide notification to the user 202 based on the same. In some embodiments, the system may send notifications to the user 202 via his/her user device 204. In this way, in some embodiments, the system may send notifications to the user 202 through electronic means. In yet other embodiments, the system may send notifications to the user 202 via non-electronic means, such as mail or the like. The notification may be via text, voice, writing, page notification, or the like.

Next, as illustrated in block 606, when a vendor statement is coming due, the system may determine a payment for the vendor statement. The payment may include any of the user's payment devices and the accounts associated therewith. The system may have received the payment device accounts from the financial institution server 208 or the user 202 via the user device 204. The payment device determined may be determined from the user's payment history associated with the vendor statement, user preference, system selection through intelligence, or the like.

Once the payment device is determined for a vendor statement the system may provide automatic payment for the vendor statement, as illustrated in block 608. In some embodiments, the user 202 may manually satisfy the vendor statement. In other embodiments, the system, as illustrated in block 608, may automatically provide for vendor statement satisfaction. As such, if a critical date or user preference payment date has is upcoming, the system may automatically satisfy the vendor statement for the user 202. The system may communicate a determined payment device for each vendor statement to the specific vendor system 210 associated with the vendor statement. In this way, the system may automatically satisfy the vendor statement via a user 202 payment device.

Next, as illustrated in block 610 the system may monitor vendor statement history 610. In this way, the system may monitor the vendor statements that the user 202 has/or has attempted to satisfy in the past. This way, the system may be able to confirm that each of the vendor statements that have been stratified, are actually satisfied that the vendor's end. The system may monitor for future vendor statements (incoming statements from a vendor, user, or the like or requesting statements from a vendor), monitor vendor statements within the user statement management program (for critical data, user preferences, updates, follow ups, and the like), and monitor vendor statement history, as illustrated here in block 610.

Finally, as illustrated in block 612, the system may flag for notification any discrepancies in vendor statements on the user statement management program. Discrepancies may include differences in amount of vendor statement from period to period, discrepancies in payment between vendor and user 202, discrepancies in timing associated with a vendor statement, and/or the like.

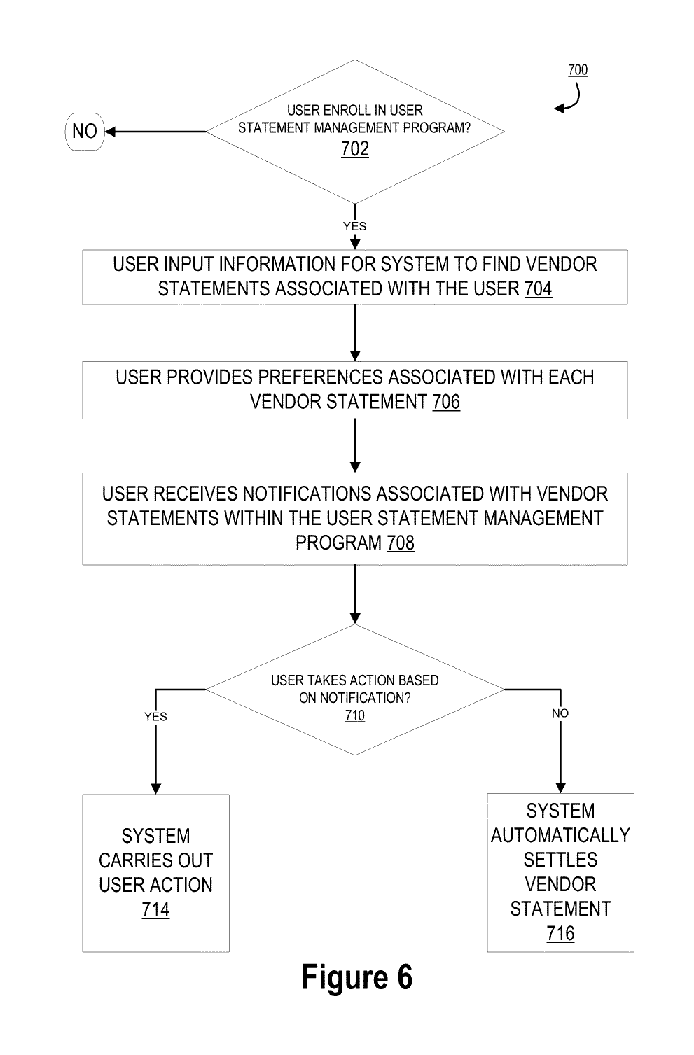

FIG. 6 illustrates a process flow for user decision process for using a statement management program 700, in accordance with one embodiment of the present invention. As illustrated in decision block 702 the user 202 may decide to enroll in the user statement management program. If the user 202 does not decide to enroll in the user statement management program, the process 700 terminates. If the user 202 decides to accept and enroll in the user statement management program, the process moves to block 704. At block 704 the user may input information for the system to find or identify vendor statements associated with the user 202. In this way, the various ways of determining vendor statements associated with a user 202 are further described above with respect to FIG. 3.

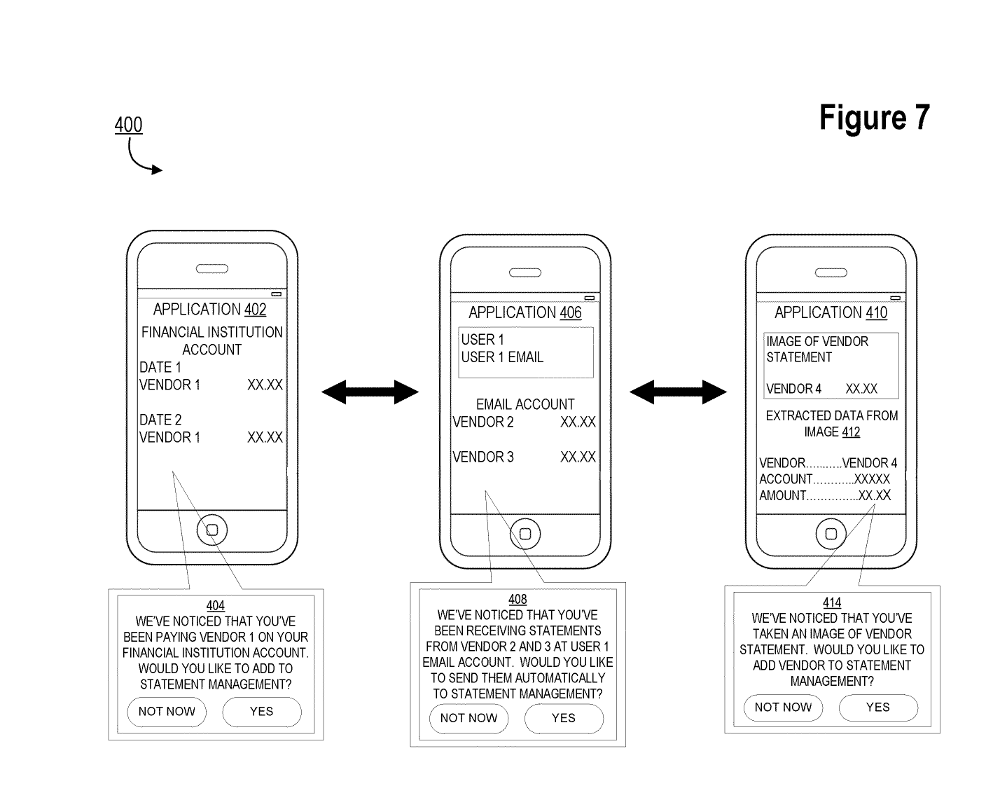

Furthermore, FIG. 7 illustrates user interfaces associated with determining vendor statements associated with a user 400, in accordance with one embodiment of the present invention. As illustrated in interface 402, the system may have recognized regular payments from the user's financial institution account. In the embodiment illustrated in interface 402 the system identified payment to Vendor 1 on Date 1 and Vendor 2 on Date 2 as potential payments to vendors for satisfying a vendor statement. As such, the system may confirm with the user 202 that he/she may wish to add Vendor 1 and/or Vendor 2 to his/her user statement management program, as illustrated in section 404. In this way, the user 202 may select the yes or the not now button.

The system may also recognize vendor statements sent to the user 202 to be added to the user statement management program. As illustrated in interface 406, the system may recognize vendor statements from Vendor 2 and Vendor 3 that have been emailed to the user 202. The system may identify a user 202 email and identify the potential vendor statements that are sent to that email address. In the interface 406, the system has identified potential vendor statements from Vendor 2 and Vendor 3. As such, the system, in section 408 may confirm with the user 202 to determine if he/she wishes to add the vendor statement to his/her user statement management program. In this way, the user 202 may select the yes or the not now button.

The system may also recognize captures of a vendor statement, such as an image or text capture. As illustrated in interface 410, the user 202 has captured an image of a vendor statement from Vendor 4. The system may extract and display data from the vendor statement, as illustrated in section 412, such as the vendor, the account associated with the vendor, and the amount of the statement. Next, the system may confirm with the user 202 that he/she wishes to add the vendor statement captured to his/her user statement management program, as illustrated in section 414. In this way, the user 202 may select the yes or the not now button.

Referring back to FIG. 6, after the user or system has provided vendor statements associated with the user 202 to the user statement management program, the user 202 may provide preferences associated with each of the various vendor statements, as illustrated in block 706. In this way, the user 202 can individualize the user preferences for each of the one or more vendor statements on the user statement management program.

Next, as illustrated in block 708 the user 202 may receive notifications associated with the vendor statements within the user statement management program. The user 202 may, in some embodiments, receive the notifications via the user device 204 or other means. Once the user 202 receives the notification, the user 202 may, in decision block 710, determine to take action based on the notification. If the user 202 decides to take action based on the notification, the system may, in some embodiments carry out the action, as illustrated in block 714. In some embodiments, the user 202 may manually act on the notification. In other embodiments, the system may carry out the user's act. If the user does not take action based on the notification, as illustrated in block 714, the system may automatically act for the user 202 if it is a critical notification, such as settling a vendor statement. In this way, the system may act on the notification without the user 202 indicating an action. This may be done if the notification is notifying the user 202 of a critical due date or other critical data associated with a vendor statement on the user statement management.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, or the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a verity of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, or the like) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for providing vendor statement management to a user, the system comprising:
a memory device with computer-readable program code stored thereon;
a communication device;
a processing device operatively coupled to the memory device and the communication device, wherein the processing device is configured to execute the computer-readable program code to:
receive one or more vendor statements from the user or from a vendor, wherein receiving the one or more vendor statements comprises receiving the one or more vendor statements electronically or from image capture, wherein the received one or more vendor statements are stored upon receipt;
identify previous vendor statements from a user's financial accounts, wherein the previous vendor statement from the user's financial account are identified based on a recognition of payments from the user's financial account to the vendor;
determine the vendors associated with the one or more vendor statement received and the previous vendor statements identified from the user's financial accounts;
monitor, based on the determined vendors, correspondence between the determined vendors and the user to identify new vendor statements;
communicate, based on the determined vendors associated with the one or more vendor statements received and the identified previous vendor statements, with the determined vendors to retrieve, automatically, the identified new vendor statements directly from the determined vendor;
consolidate all vendor statements including the received one or more vendor statements, the identified previous vendor statements, and the retrieved new vendor statements, wherein the consolidated vendor statements are associated with the user;
determine critical vendor data associated with the consolidated vendor statements, wherein the critical vendor data includes satisfaction dates and payment amount due for satisfaction; and
provide, automatically, payment for satisfaction of the consolidated vendor statements directly to the vendor from the user's financial accounts.

2. (canceled)

3. (canceled)

4. (canceled)

5. The system of claim 1, wherein the processing device further comprises determining a user payment device for satisfaction of vendor statements is determined by one or more of vendor statement payment history, artificial intelligence, or user input.

6. The system of claim 1, wherein vendor data comprise one or more of vendor account, payment required for satisfaction, past user payment device for satisfying a previous vendor statement, and user name associated with the vendor.

7. The system of claim 1, wherein the processing device is further configured to notify the user of any pending critical vendor data and pending user preferences associated with any of the one or more consolidated vendor statements.

8. The system of claim 1, wherein providing payment for satisfaction of the consolidated vendor statements directly to the vendor occurs without user interaction, wherein providing payment for satisfaction occurs before the critical vendor date.

9. The system of claim 8 wherein the processing device is further configured to continually monitoring the vendor and vendor statement associated with the satisfied vendor statement for confirmation of satisfaction.

10. The system of claim 1, wherein the processing device is further configured to flag discrepancies in the received one or more vendor statements and the retrieved new vendor statements vendor statements, wherein the discrepancies are differences in previously received or retrieved vendor statements and currently received or retrieved vendor statements.

11. The system of claim 1, wherein the processing device is further configured to monitor vendor statement history for the user.

12. The system of claim 1, wherein the vendor statement is one or more of an invoice for services rendered or a bill for purchasing a product.

13. A computer program product for providing vendor statement management to a user, the computer program product comprising at least one non-transitory computer-readable medium having computer-readable program code portions embodied therein, the computer-readable program code portions comprising:
an executable portion configured for receiving one or more vendor statements from the user or from a vendor, wherein receiving the one or more vendor statements comprises receiving the one or more vendor statements, wherein the received one or more vendor statements are stored upon receipt;
an executable portion configured for identifying previous vendor statements from a user's financial accounts, wherein the previous vendor statement from the user's financial account are identified based on a recognition of payments from the user's financial account to the vendor;
an executable portion configured for determining the vendors associated with the one or more vendor statement received and the previous vendor statements identified from the user's financial accounts;
an executable portion configured for monitoring, based on the determined vendors, correspondence between the vendor and the user to identify new vendor statements;
an executable portion configured for communicating, based on the determined vendors associated with the one or more vendor statements received and the identified previous vendor statements, with the determined vendors to retrieve, automatically, the identified new vendor statements directly from the determined vendor;
an executable portion configured for consolidating all vendor statements including the received one or more vendor statements, the identified previous vendor statements, and the retrieved new vendor statements, wherein the consolidated vendor statements are associated with the user;
an executable portion configured for determining critical vendor data associated with the consolidated vendor statements, wherein the critical vendor data includes satisfaction dates and payment amount due for satisfaction; and
an executable portion configured for providing, automatically, payment for satisfaction of the consolidated vendor statements directly to the vendor from the user's financial accounts.

14. (canceled)

15. The computer program product of claim 13, further comprising an executable portion configured for determining a user payment device for satisfaction of vendor statements is determined by one or more of vendor statement payment history, artificial intelligence, or user input.

16. The computer program product of claim 13, wherein vendor data comprise one or more of vendor account, payment required for satisfaction, past user payment device for satisfying a previous vendor statement, and user name associated with the vendor.

17. The computer program product of claim 13, further comprising an executable portion configured for notifying the user of any pending critical vendor data and pending user preferences associated with any of the one or more consolidated vendor statements.

18. The computer program product of claim 13, wherein providing payment for satisfaction of the consolidated vendor statements directly to the vendor occurs without user interaction, wherein providing payment for satisfaction occurs before the critical vendor date.

19. The computer program product of claim 18, further comprising an executable portion configured to continually monitoring the vendor and vendor statement associated with the satisfied vendor statement for confirmation of satisfaction.

20. The computer program product of claim 13, further comprising an executable portion configured flagging discrepancies in the received one or more vendor statements and the retrieved new vendor statements vendor statements, wherein the discrepancies are differences in previously received or retrieved vendor statements and currently received or retrieved vendor statements.

21. A computer-implemented method for providing vendor statement management to a user, the method comprising:
receiving one or more vendor statements from the user or from a vendor, wherein receiving the one or more vendor statements comprises retrieving the one or more vendor statements electronically or from image capture, wherein the received one or more vendor statements are stored upon receipt;
identifying previous vendor statements from a user's financial accounts, wherein the previous vendor statement from the user's financial account are identified based on a recognition of payments from the user's financial account to the vendor;
determining the vendors associated with the one or more vendor statement received and the previous vendor statements identified from the user's financial accounts;
monitoring, based on the determined vendors, correspondence between the vendor and the user to identify new vendor statements;
communicating, based on the determined vendors associated with the one or more vendor statements received and the identified previous vendor statements, with the determined vendors to retrieve, automatically, the identified new vendor statements directly from the determined vendor;
consolidating all vendor statements including the received one or more vendor statements, the identified previous vendor statements, and the retrieved new vendor statements, wherein the consolidated vendor statements are associated with the user;
determining critical vendor data associated with the consolidated vendor statements, wherein the critical vendor data includes satisfaction dates and payment amount due for satisfaction; and
providing, automatically, payment for satisfaction of the consolidated vendor statements directly to the vendor from the user's financial accounts.

22. (canceled)

23. The method of claim 21, further comprising determining a user payment device for satisfaction of vendor statements is determined by one or more of vendor statement payment history, artificial intelligence, or user input.

24. The method of claim 21, further comprising notifying the user of any pending critical vendor data and pending user preferences associated with any of the one or more consolidated vendor statements.

25. The method of claim 21, wherein providing payment for satisfaction of the consolidated vendor statements directly to the vendor occurs without user interaction, wherein providing payment for satisfaction occurs before the critical vendor date.

26. The method of claim 25, further comprising continually monitoring the vendor and vendor statement associated with the satisfied vendor statement for confirmation of satisfaction.

27. The method of claim 21, further comprising flagging discrepancies in the received one or more vendor statements and the retrieved new vendor statements vendor statements, wherein the discrepancies are differences in previously received or retrieved vendor statements and currently received or retrieved vendor statements.
